(19) United States
(12) Patent Application Publication
(10) Pub. No.: US 2018/0119610 A1
(43) Pub. Date: May 3, 2018

(54) MODULAR AND SERVICEABLE ELECTROMAGNETIC CLUTCH ASSEMBLY

(71) Applicant: EATON CORPORATION, CLEVELAND, OH (US)

(72) Inventor: MICHAEL J HORNBROOK, ORLAND, IN (US)

(73) Assignee: EATON CORPORATION, CLEVELAND, OH (US)

(21) Appl. No.: 15/575,643

(22) PCT Filed: May 19, 2016
(86) PCT No.: PCT/US2016/033214

§ 371 Date: Nov. 20, 2017

Related U.S. Application Data
(60) Provisional application No. 62/164,172, filed on May 20, 2015.

(51) Int. Cl. F02B 39/12; F02B 33/36; F16D 27/06

(52) U.S. Cl. CPC F02B 39/12; F16D 2300/12; F16D 27/06; F02B 33/36

(57) ABSTRACT

An electromagnetic clutch assembly comprises an input shaft comprising a longitudinal axis. A rotor assembly is coupled to the input shaft. A solenoid assembly is coupled to transfer electromagnetic flux to the rotor assembly. An armature is coupled to the input shaft. The armature is configured to circulate electromagnetic flux received from the rotor assembly when a coil is energized, and is further configured to move along the longitudinal axis towards the rotor assembly. At least one armature plate is configured to freely float between the armature and the rotor assembly when the coil is not energized and is configured to provide a friction grip between the armature and the rotor assembly when the coil is energized. The at least one armature plate comprises outer alignment slots. A securement retains the armature and at least one armature plate to the input shaft for serviceability.

### FIELD

This application relates to electromagnetic clutches, and ones adapted for use in supercharging systems.

### BACKGROUND

Current configurations of a supercharger integral clutch can be seen in examples such as U.S. Pat. No. 8,464,697 and WO 2014/182350, incorporated herein by reference in their entirety. Both designs have a basic electromagnetic single plate design. And, both have embodiments with an armature that is coupled to a disc via springs. The springs can be bolted or screwed in place, and this is bulky. When energized, the armature plate is pulled against the clutch rotor and the magnetic force creates load torque between the two surfaces. One issue is that, as applications increase in speed, more frictional surface area is required to accommodate the increase in energy and temperature. Failure to do this will result in plate distortion and thermal damage. With this clutch configuration, the only way to increase surface area is to increase the diameter of the clutch. This becomes problematic from an engine packaging perspective.

### SUMMARY

The devices and methods disclosed herein overcome the above disadvantages and improves the art by way of a modular and serviceable clutch.

An electromagnetic clutch assembly comprises an input shaft configured to receive torque, the input shaft comprising a longitudinal axis. A rotor assembly is rotatably coupled to the input shaft. A stationary solenoid assembly is coupled around the input shaft and is coupled to transfer electromagnetic flux to the rotor assembly. The solenoid assembly comprises a core and an energizable coil assembly surrounding the core. An armature is coupled to the input shaft. The armature is configured to circulate electromagnetic flux received from the rotor assembly when the coil is energized, and is further configured to move along the longitudinal axis towards the rotor assembly when the coil is energized. At least one armature plate is between the armature and the rotor assembly, the at least one armature plate is configured to freely float between the armature and the rotor assembly when the coil is not energized and is configured to provide a friction grip between the armature and the rotor assembly when the coil is energized. The at least one armature plate comprises outer alignment slots extending radially outward past the armature. The at least one armature plate is configured to transfer electromagnetic flux between the armature and the rotor assembly. A securement retains the armature and at least one armature plate to the input shaft such that the at least one armature plate is serviceable.

A supercharger can comprise the electromagnetic clutch assembly, wherein the clutch assembly is modular and is installed to the supercharger housing according to a drop-in assembly technique. The supercharger can comprise a main housing comprising a rotor bore and rotatable lobed rotors in the rotor bore. Torque transferring mechanisms can be mounted to the main housing, the torque transferring mechanisms comprising at least an output shaft for transferring torque to the rotatable lobed rotors. An outlet plate can be mounted to the output shaft, the outlet plate comprising drive lugs that removably seat in the outer alignment slots.

Additional objects and advantages will be set forth in part in the description which follows, and in part will be obvious from the description, or may be learned by practice of the disclosure. The objects and advantages will also be realized and attained by means of the elements and combinations particularly pointed out in the appended claims.

It is to be understood that both the foregoing general description and the following detailed description are exemplary and explanatory only and are not restrictive of the claimed invention.

### BRIEF DESCRIPTION OF THE DRAWINGS

FIG. 1 is a cross-section view of a clutch assembly.

FIG. 2 is a cross-section view of a clutch assembly with respect to a supercharger assembly and step up gear assembly.

FIG. 3 is an exploded view of a clutch assembly.

FIGS. 4A & 4B are cross-section views of alternative clutch assemblies.

FIG. 5 is a cross-section view of a clutch assembly with respect to a supercharger assembly and step up gear assembly.

FIG. 6 is an exploded view of the clutch assembly of FIG. 4B.

FIG. 7 is a perspective view of a clutch assembly.

FIG. 8 is a perspective view of an output shaft assembly.

### DETAILED DESCRIPTION

Reference will now be made in detail to the examples which are illustrated in the accompanying drawings. Wherever possible, the same reference numbers will be used throughout the drawings to refer to the same or like parts. Directional references such as “left” and “right” are for ease of reference to the figures.

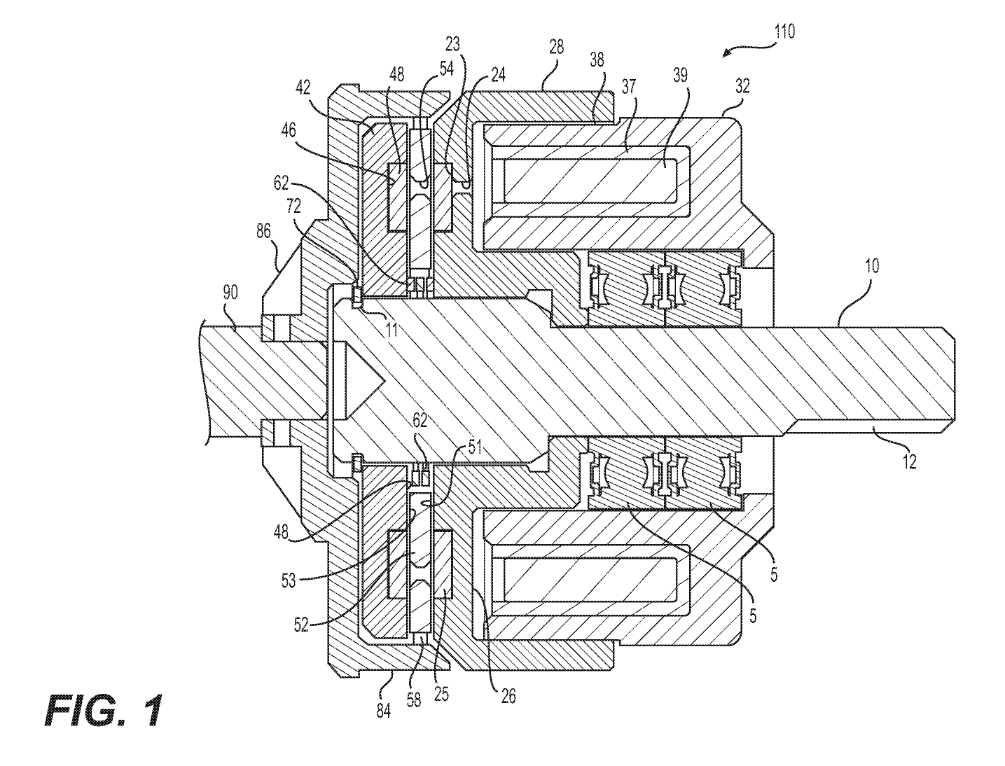

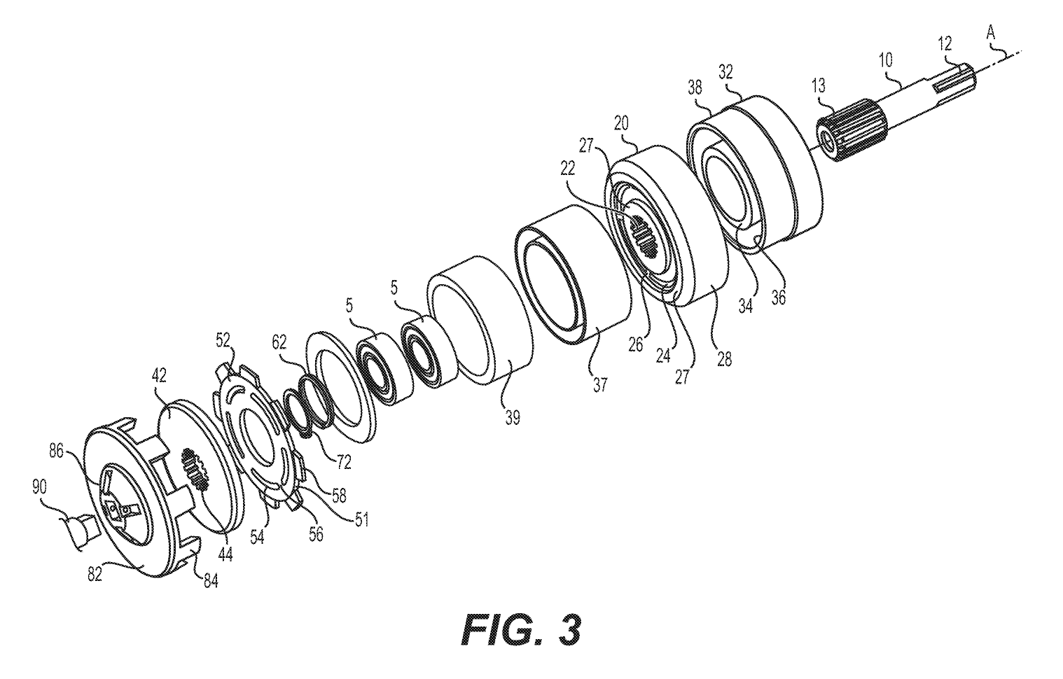

FIGS. 1-3 show an electromagnetic clutch assembly 110, comprising an input shaft 10 configured to receive torque. One torque transfer technique can use a spline coupling to grooves in transfer area 12 to another powered device, or can use a press-fit to a pulley hub 14, for example. The input shaft comprises a longitudinal axis A.

A stationary solenoid assembly 30 is coupled around the input shaft 10 and is coupled to transfer electromagnetic flux to a rotor assembly 20. The solenoid assembly 30 comprises an energizable coil 39 in epoxy or on a bobbin 37. The core of the solenoid assembly can be formed by the neck of the rotor 20, the input shaft 10 or the solenoid housing core 34, or a combination of these. Wiring 25 can connect to a power and control source to provide selective, programmable electrification to the coil 39. The solenoid assembly 30 can further comprise mounting features for the wiring, and a spool or mandrel type device for the coil.

A rotor assembly 20 is coupled to the input shaft 10 via splines 22 to configure the rotor assembly to rotate with the input shaft. In the alternative, it is possible to couple the rotor via press-fit. Rotor assembly 20 comprises a housing extension 28, and the housing extension 28 extends externally around a flux transfer zone 38 of a solenoid housing 32 to transfer electromagnetic flux between the solenoid housing 32 and the rotor assembly 20.

Rotor assembly comprises radial cut-outs 24 for directing electromagnetic flux. Stays 26 between the radial cut-outs 24 provide structural stability. Further flux modulation can be performed by controlling the radial extent and depth of recess 23. Recess 23 can receive abradable friction material. Electromagnetic flux can circulate along poles created on either side of the recess 23 and on either side of the radial cut-outs 24. The coupling strength of the clutch can be modified by controlling the recess 23 and cut-outs 24.

As mentioned above, one aspect of clutch coupling strength can be modified by increasing a contact area of a rotor and armature combination. This carries over to the instant disclosure, in that coupling surfaces 27 on the rotor can be made larger for greater grip. The coupling surfaces 27 can also be modified for modulating the electromagnetic flux strength. Unlike the prior art mentioned above, it is possible to increase clutch coupling strength beyond mere additions to the coupling surfaces 27. That is, the clutch coupling strength can be increased without adding to the diameter of the rotor to add area to the coupling surfaces 27. Also, the clutch coupling strength can be additively enhanced by increasing the diameter of the rotor coupling surfaces 27. The increase can be by way of at least one armature plate 52 to increase the amount of friction contact for torque transfer.

In FIGS. 1-3, the at least one armature plate 52 is a single armature plate between an armature 42 and the rotor assembly 20. The at least one armature plate 52 is configured to freely float between the armature 42 and the rotor assembly 20 when the coil 39 is not energized, and is configured to provide a friction grip between the armature 42 and the rotor assembly 20 when the coil 39 is energized. The at least one armature plate 52 comprises outer alignment slots 51 extending radially outward past the armature 42. Sections 58 of the armature plate extend outwardly like teeth. The at least one armature plate 52 is configured to transfer electromagnetic flux between the armature 42 and the rotor assembly 20. As above, radial cut-outs 54 provide a trade-off between friction contact area and the strength of the electromagnetic flux poles. Stays 56 provide structural integrity to the disc-like armature plate 52.

An armature 42 is coupled via spline 44 to the spline 13 of the input shaft 10. Using a spline coupling makes the armature 42 removable for serviceability and permits the armature to slide along the longitudinal axis A of the input shaft 10. Armature 42 is configured to circulate electromagnetic flux received from the rotor assembly 20 when the coil 39 is energized, and is further configured to move along the longitudinal axis A towards the rotor assembly 20 when the coil 39 is energized. Energizing the coil 39 creates an electromagnetic field that draws the armature 42 towards the rotor assembly 20, which clamps the at least one armature plate 52. Coupling surface 48 of armature can have a friction material to grip first side 53 of armature plate 52. Coupling surface 27 of rotor can have a friction material to grip second side 51 of armature plate 52.

With the armature plate 52 clamped, a friction grip material on the first side 53 and on the second side 51 of the armature plate 52 provide friction grip for transferring torque from the input shaft 10 to an output shaft 90. The rotor assembly 20 can comprise a first section 25 of friction material in recess 23. The armature 42 can comprise a second section 48 of friction material in recess 46. Because the friction grip material is on both sides of the armature plate 52, a portion of the friction grip material can grip both of the first section 25 and the second section 48 of friction material to provide the friction grip. In FIG. 1, friction grip material on the first side 53 grips second section 46, while friction grip material on the second side 51 grips first section 25. In the interleaved examples of later embodiments, interposing plates prevent one armature plate from contacting both the armature and the rotor assembly, but the totality of friction surfaces collectively grip together to transfer torque, and a first side of one plate can contact the armature, while a second side of another armature plate can contact the rotor assembly. The friction material and friction grip material can be any one of an epoxy, sintered metal, button insert, overmold, bonded material. Many materials are available, including epoxies, powders, paper, pyrolytic carbon, etc. One or both of the friction material and friction grip material can be abradable. To facilitate easy serviceability, one of the friction material and the friction grip material can be chosen to abrade faster than the other so that, for example, the armature plate can be replaced with a fresh friction grip material before any servicing is needed to the rotor assembly 20. Or, the armature 42 is replaceable prior to the rotor assembly 20.

To facilitate clutch disengagement, a variety of compliance members can be provided. FIG. 1 illustrates a wave spring 62, between the armature 42 and the rotor assembly 20. Alternatively, the armature plate can comprise a notch or bend for providing compliance between the armature 42 and the rotor assembly 20. Elastomeric members, such as o-rings, can also be used to bias the rotor assembly and armature apart.

A securement 72 retains the armature 42 to the input shaft 10. In the figures, a snap ring is shown in a groove 11. Other mechanisms, such as pins and clips are alternatively usable to make the at least one armature plate 52 serviceable.

One or more bearing assemblies 5 can permit the solenoid housing 32 to remain stationary with respect to the input shaft 10. At least one bearing assembly 5 is coupled between the input shaft 10 and the solenoid housing 32 to permit rotation of the input shaft 10 within the solenoid housing 32

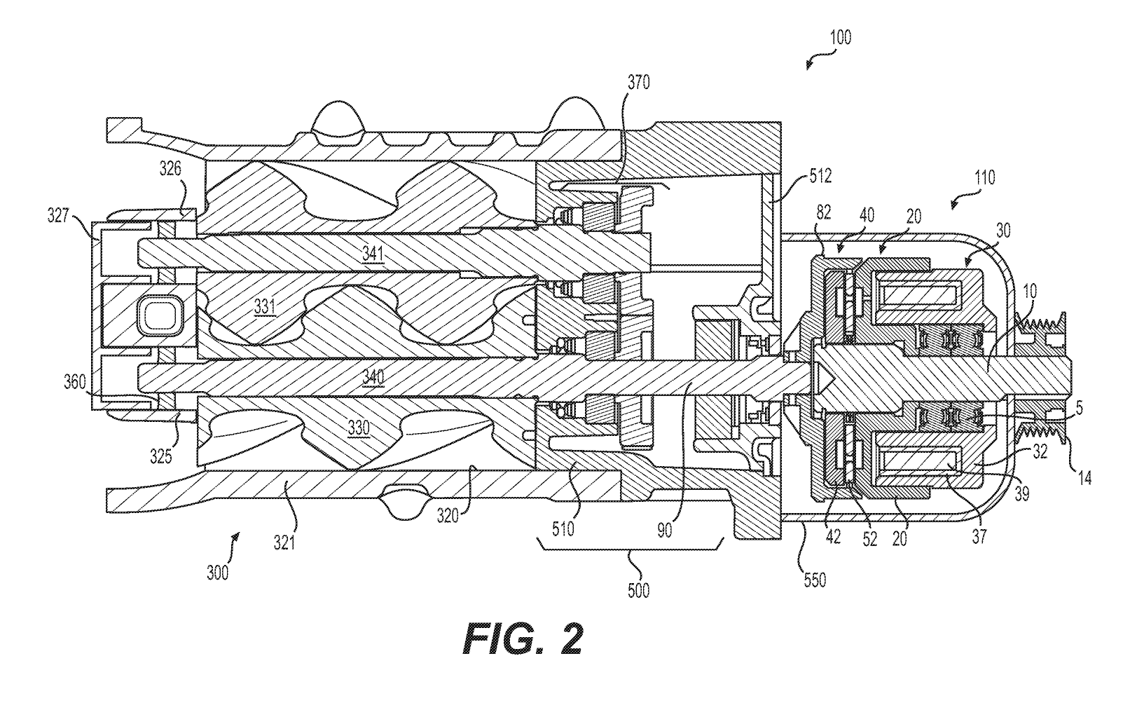

For flux tailoring reasons, the rotor assembly of FIGS. 1-3 uses housing extension 28. However, the rotating housing extension 28 must be protected, and so an additional housing cup 550 can be included to secure the clutch assembly to its target device. In FIG. 2, the target device is a supercharger assembly 300.

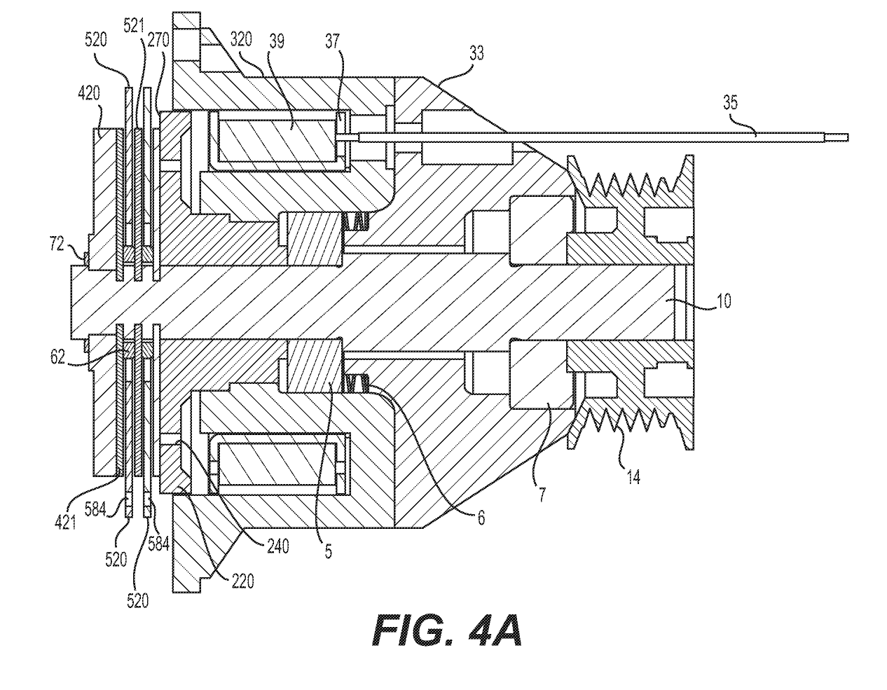

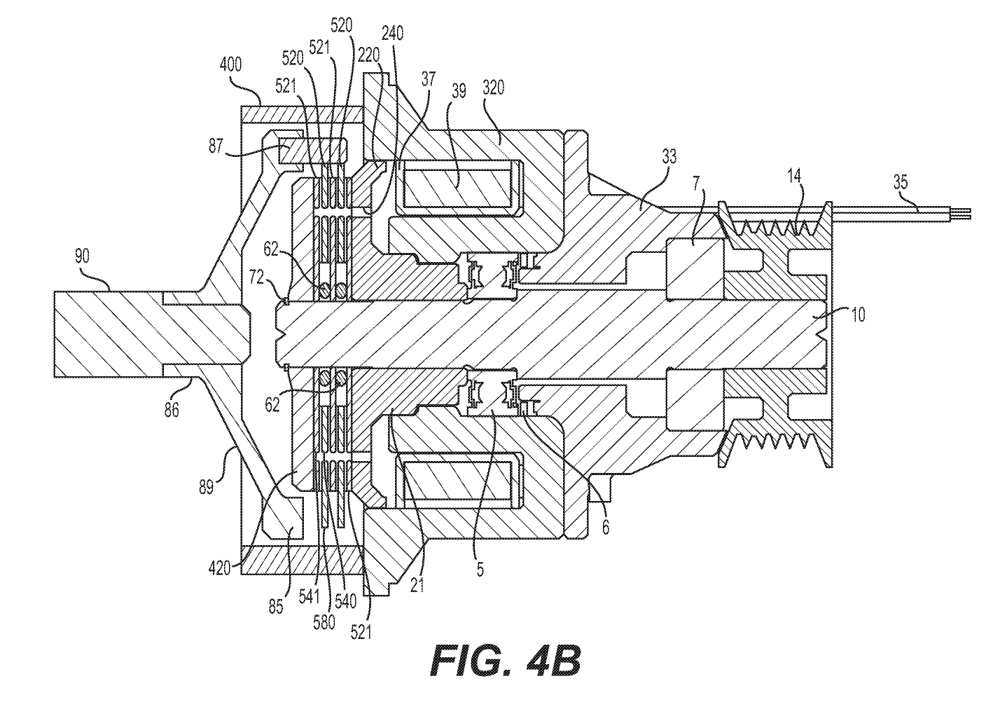

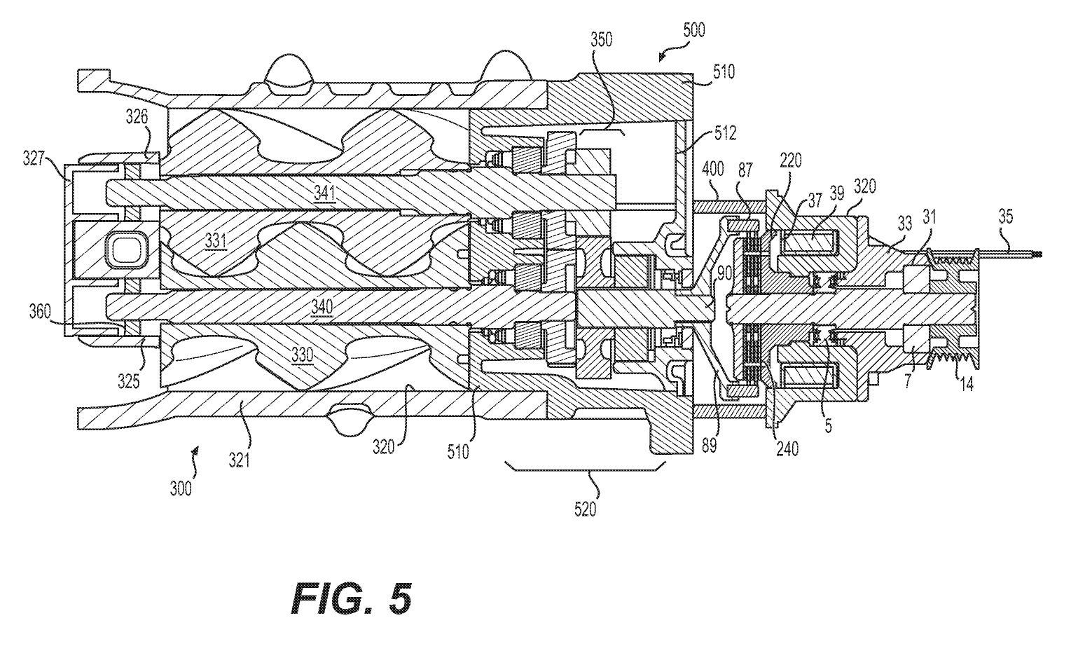

An alternative to this external rotating member redirects the flux pathway, with concomitant accommodations for flux strength. The assembly of FIGS. 4A-6 illustrate a rotor assembly 220 that rotates within the solenoid housing 320. The solenoid housing 320 can be direct-coupled to its target device when the sides of the housing extend past the armature plates 520. Otherwise a housing spacer 400 or 401 can interpose the solenoid housing 320 and the target device. In FIG. 5, the target device is a supercharger assembly 300. In FIGS. 4B, 5 & 7, the outlet plate 89 rotates within its respective housing s 400, 401.

Many aspects of FIGS. 1-3 appear in FIGS. 4A-6 and will not be repeated below, but are incorporated from above.

In FIG. 4A, solenoid housing 320 rotates with respect to input shaft 10. Bearing 5 permits input shaft 10 to rotate, while solenoid housing 320 is stationary. An additional housing cup 33 interposes the solenoid housing 320 and the input pulley 14. Bearing 7 permits input shaft 10 to rotate while housing cup 33 is stationary. A spring 6, such as a wave spring, can bias outer race of bearing 5 to counter forces pushing back from the output shaft 90 which can prevent squeal in the bearing 5 during operation.

The rotor assembly 220 is splined to the input shaft, or press-fit. Radial cut-outs 240 are included for flux path tailoring and stays 260 can be, as above, included for stability. Housing core 344 can be the electromagnetic core of the solenoid assembly, or input shaft 10 or a neck of rotor 220, or a combination of these. A bobbin 37 can be included, or the coil 39 can be coated in epoxy to physically isolate the coil 39 from its surroundings. The rotor assembly coupling surface 270 can, as above, include one or both of a friction material and a recess. With the inclusion of multiple armature plates 520 & 521, however, the coupling surface 270 benefits from having a low level of abradability to retain the integrity of the rotor through serviceability periods.

The at least one armature plate, in FIGS. 4A-6, is multiple plates: one or more drive armature plates 520 and one or more driven armature plates 521. A driven armature plate 521 can comprise a friction grip material and can contact the rotor assembly 220. Another driven armature plate 521 can comprise friction grip material and can contact the armature 420. The driven armature plates 521 are indexed to the input shaft 10 to receive torque. One or more drive armature plates 520 can float, or reciprocate, between the armature 420 and rotor assembly 220 until the armature 420 is drawn to the rotor assembly 220 by the presence of an electromagnetic flux field. Armature can, as above, include one or both of a friction material and a recess. To facilitate modularity, a snap ring in a groove, or clip or pin can be securement 72.

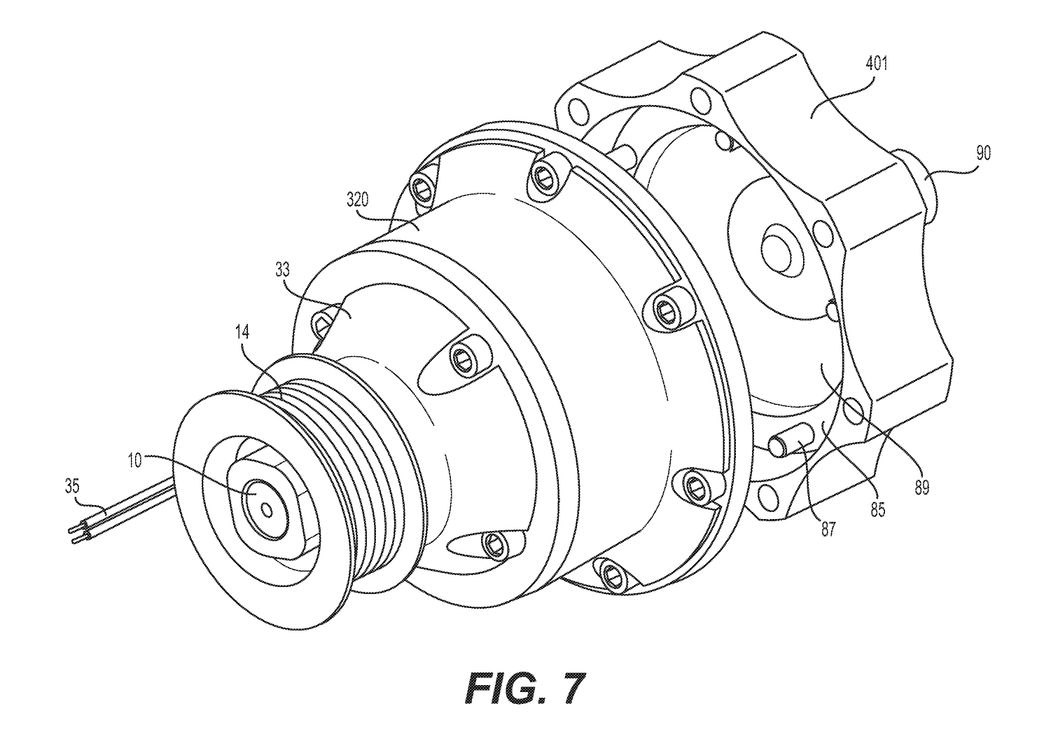

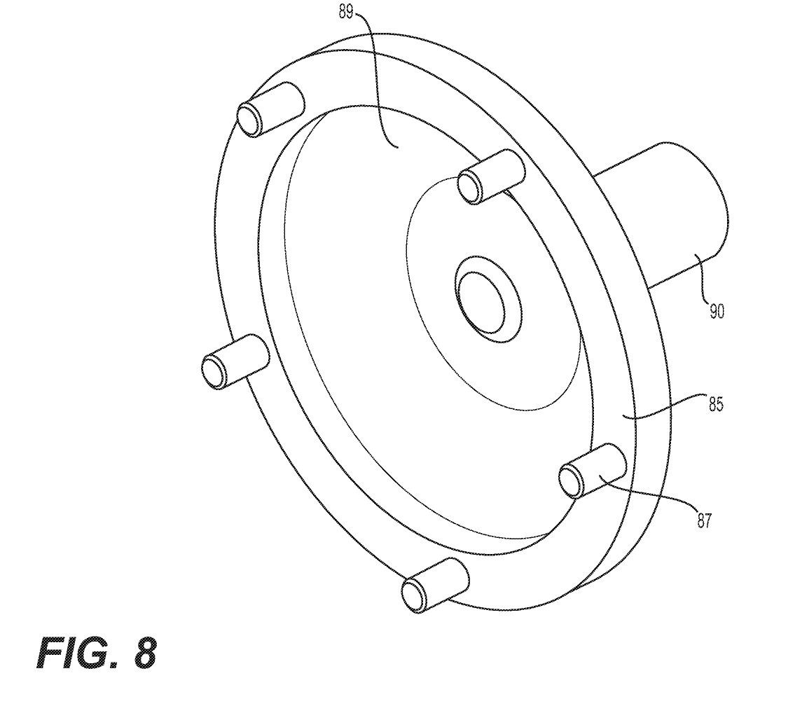

FIG. 4A also includes outer alignment slots 584 in the drive armature plates 520. The outer alignment slots 584 pass through the drive armature plates 520 and couple to drive lugs 87 of outlet plate 89, shown in FIGS. 7 & 8. The drive lugs 87 can be, for example, dowel pins or screwed pins. The drive armature plates can reciprocate along the longitudinal axis A and can slide off of the drive lugs 87 for serviceability.

Because the drive armature plates 520 can be slide on to the drive lugs 87, a drop-in assembly technique can be used, which is a huge time savings for modularity and serviceability.

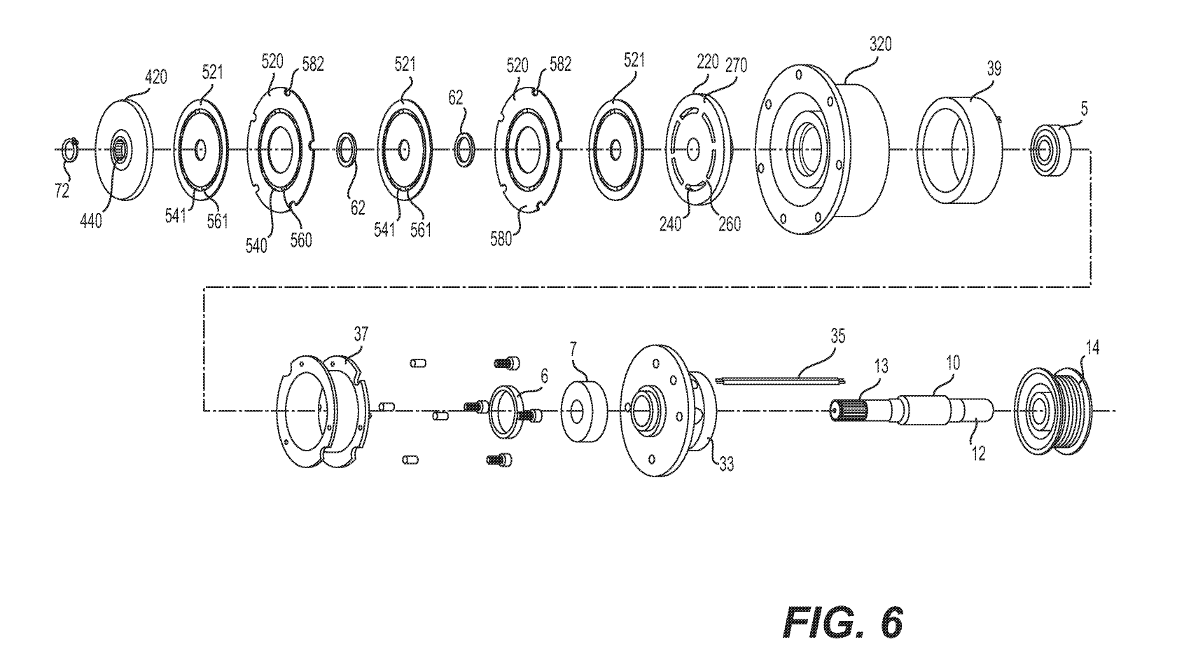

In FIG. 4B, the drive lugs 87 are shown inserted in to a rim 85 of the output plate 89, and a coupling neck 86 interfaces with output shaft 90. In FIGS. 1-3, the drive lugs 84 are integrally formed with the outlet plate 89. Radial slots 541 & 540 are shown, respectively, in the driven armature plate 521 and the drive armature plate 520, for directing the electromagnetic flux patter and create poles. Stays 561 & 560 are also shown. Sections 580 of the drive armature plate 520 extend past the armature 420 to catch against the drive lugs 87. As shown in FIG. 6, the outer alignment slots 582 can be U-shaped slots for ease of serviceability.

Energizing the coil 39 in FIGS. 4A-6 pulls the armature coupling surface 421 towards the rotor assembly coupling surface 270. This collapses the expanded friction disc pack, restricting the longitudinal free play of the driven armature plate 521 and the longitudinal free play of the drive armature plate 520. Friction grip material on the at least one armature plate grip to transfer torque.

The outer alignment slots 582 of the at least one armature plate 520, 521 align with drive lugs 87 of an outlet plate 89 to transfer torque from the input shaft 10 to an output shaft 90 when the coil 39 is energized.

While the modular and serviceable clutch assembly can be used with a variety of target devices, it is shown in FIGS. 2 & 5 affiliated with an exemplary supercharger assembly 300. A main housing 321 includes a rotor bore 321 with two lobed rotors 330, 332 on rotor shafts 341 & 340. Additional housing members such as walls 326, extensions 327, end caps 325, plates, bearings 360, etc. cooperate to brace a first end of the rotor shafts 341 & 340. Fluid inlet and outlet are not shown. Main housing 321 can be integrally formed with, or have press fit in to it, a bearing plate 510. The bearing plate 510 can comprise a variety of torque transferring mechanisms 500, including gear sets such as timing gears 370 and step-up gears 350. The torque transferring mechanisms 500 can be lubricated, and so a cover plate 512 can be used to seal lubricant within the bearing plate 510. Seals can be included on the bearing plate 512 and cover plate 512 as needed.

The output shaft 90 can be installed in a gear set of the supercharger assembly 300. In FIG. 2, the output shaft is supported by a bearing, but direct couples to the rotor shaft 340. A timing gear transfers torque from output shaft 90 to rotor shaft 341. In FIG. 5, the output shaft is integrated in to the step-up gear set, and the step-up gear set interfaces with timing gears, bearings, and other support mechanisms to transfer torque from the input shaft 10 to the lobed rotors 331 & 330. Because the output shaft 90 is so embedded in the target device, it is not easy to service the output shaft 90. In the prior art, the clutch is embedded in the target device and it damages alignment and usability to tamper with the prior art clutch. Prior art clutch failure results in tear down of the gear set to extricate the faulty clutch. In this disclosure, should the clutch assembly 110, 112, 114 fail, it is not necessary to disrupt the torque transferring mechanisms 500, 520. The lubricant in bearing plate 510 need not be disturbed, the cover plate 512 need not be removed.

The modularity of the disclosed clutch assembly 110, 112, 114 permits the combination of a “wet” gear assembly with a serviceable “dry” clutch. The disclosure alleviates the difficulty of combining a dry clutch with a wet gear set by permitting isolation and serviceability of the clutch. The output shaft 90 can remain in the supercharger bearing plate assembly 512, and the output plate 89 can remain affixed to the output shaft 90. The clutch assembly 110, 112, 114 can be removed from the supercharger assembly 300 and serviced. If total failure of the clutch assembly has occurred, it is not necessary to replace the supercharger assembly. Rather, a modular clutch assembly can replace the failed clutch assembly. This saves the end user great expense and labor and alleviates waste.

When the output shaft 90 and or outlet plate 89 is installed to a gear set 350 or 370 of the supercharger 300, the drive lugs 84, 87 seat in and are separable from the outer alignment slots 51, 582, 584 of the at least one armature plate for servicing the at least one armature plate. The at least one armature plate can slide away from the drive lugs 84, 87, and a new clutch assembly can be “dropped in,” or slid on to the drive lugs 84, 87 according to a drop-in assembly technique.

When the armature 42 compresses the at least one armature plate 52, the at least one armature plate 52 transfer torque via the outer alignment slots 51 to lugs 84, 87. Torque then transfers to the output plate 89 and up to the output shaft 90. When the armature 420 compresses the at least one armature plates 521, 520 together, the indexed driven armature plates 521 transfer torque from the input shaft 10 to the drive armature plates 520. The drive armature plates 520 transfer torque via the outer alignment slots 582, 584 to lugs 84, 87. Torque then transfers to the output plate 89 and up to the output shaft 90.

Other implementations will be apparent to those skilled in the art from consideration of the specification and practice of the examples disclosed herein.

What is claimed is:

1. An electromagnetic clutch assembly, comprising:
an input shaft configured to receive torque, the input shaft comprising a longitudinal axis;
a rotor assembly coupled to the input shaft and configured to rotate with the input shaft;
a stationary solenoid assembly coupled around the input shaft and coupled to transfer electromagnetic flux to the rotor assembly, the solenoid assembly comprising a core and an energizable coil assembly surrounding the core;
an armature coupled to the input shaft, the armature configured to circulate electromagnetic flux received from the rotor assembly when the coil is energized, and further configured to move along the longitudinal axis towards the rotor assembly when the coil is energized;
at least one armature plate between the armature and the rotor assembly, the at least one armature plate configured to freely float between the armature and the rotor assembly when the coil is not energized and configured to provide a friction grip between the armature and the rotor assembly when the coil is energized, the at least one armature plate comprising outer alignment slots extending radially outward past the armature, the at least one armature plate configured to transfer electromagnetic flux between the armature and the rotor assembly; and
a securement retaining the armature and at least one armature plate to the input shaft such that the at least one armature plate is serviceable.

2. The assembly of claim 1, wherein the securement comprises one of a snap ring, a pin, and a clip.

3. The assembly of claim 1, further comprising a compliant member between the armature and the rotor assembly.

4. The assembly of claim 1, wherein the at least one armature plate comprises a notch or bend for providing compliance between the armature and the rotor assembly.

5. The assembly of claim 1, further comprising a solenoid housing and at least one bearing assembly, the bearing assembly coupled between the input shaft and the solenoid housing to permit rotation of the input shaft within the solenoid housing.

6. The assembly of claim 5, wherein the rotor assembly rotates within the solenoid housing.

7. The assembly of claim 5, wherein the rotor assembly comprises a housing extension, and the housing extension extends externally around the solenoid housing to transfer electromagnetic flux between the solenoid housing and the rotor assembly.

8. The assembly of claim 1, wherein the rotor assembly comprises radial cut-outs for directing electromagnetic flux.

9. The assembly of claim 1, wherein each of the at least one armature plate comprises a first side and a second side, and a friction grip material on the first side and on the second side to provide the friction grip.

10. The assembly of claim 9, wherein the rotor assembly comprises a first section of friction material, wherein the armature comprises a second section of friction material, and wherein a portion of the friction grip material of the at least one armature plate couples to one or both of the first section and the second section of friction material to provide the friction grip.

11. The assembly of claim 10, wherein the rotor assembly comprises a recess for receiving the first section of friction material.

12. The assembly of claim 10, wherein the armature comprises a recess for receiving the second section of friction material.

13. The assembly of claim 9, wherein the friction grip material is abradable against the rotor and is abradable against the armature, and wherein the clutch assembly is serviceable to replace the at least one armature plate when the friction grip material abrades against the rotor and against the armature.

14. The assembly of claim 1, wherein the at least one armature plate comprises radial cut-outs for directing electromagnetic flux.

15. The assembly of claim 1, wherein the outer alignment slots of the at least one armature plate align with drive lugs of an outlet plate to transfer torque from the input shaft to an output shaft when the coil is energized.

16. The assembly of claim 1, further comprising an output shaft coupled to an outlet plate, and the outlet plate comprises drive lugs for seating in the outer alignment slots.

17. The assembly of claim 16, wherein the at least one armature plate comprises one or more drive armature plates comprising the outer alignment slots and the at least one armature plate comprises one or more driven armature plates splined to the input shaft, wherein the one or more driven armature plate couples torque from the input shaft to the drive armature plate when the coil is energized.

18. The assembly of claim 17, wherein the output shaft is installed in a gear set of a supercharger, wherein the outlet plate is installed to the gear set of the supercharger, and wherein the drive lugs are separable from the at least one armature plate for servicing the at least one armature plate.

19. The assembly of claim 17, wherein the output shaft is installed in a gear set of a supercharger, wherein the outlet plate is installed to the gear set of the supercharger, and wherein the drive lugs seat in the outer alignment slots of the at least one armature plate according to a drop-in assembly technique.

20. A supercharger comprising:
a main housing comprising a rotor bore and rotatable lobed rotors in the rotor bore;
torque transferring mechanisms mounted to the main housing, the torque transferring mechanisms comprising at least an output shaft for transferring torque to the rotatable lobed rotors;
an outlet plate mounted to the output shaft, the outlet plate comprising drive lugs; and
an electromagnetic clutch assembly, comprising:
an input shaft configured to receive torque, the input shaft comprising a longitudinal axis;
a rotor assembly coupled to the input shaft and configured to rotate with the input shaft;
a stationary solenoid assembly coupled around the input shaft and coupled to transfer electromagnetic flux to the rotor assembly, the solenoid assembly comprising a core and an energizable coil assembly surrounding the core;
an armature coupled to the input shaft, the armature configured to circulate electromagnetic flux received from the rotor assembly when the coil is energized, and further configured to move along the longitudinal axis towards the rotor assembly when the coil is energized; and
at least one armature plate between the armature and the rotor assembly, the at least one armature plate configured to freely float between the armature and the rotor assembly when the coil is not energized and configured to provide a friction grip between the armature and the rotor assembly when the coil is energized, the at least one armature plate comprising outer alignment slots extending radially outward past the armature, the at least one armature plate configured to transfer electromagnetic flux between the armature and the rotor assembly,
wherein the clutch assembly is modular and is installed to the supercharger housing according to a drop-in assembly technique, and
wherein the drive lugs removably seat in the outer alignment slots.
